(19) United States
(12) Patent Application Publication
(10) Pub. No.: US 2002/0069156 A1
(43) Pub. Date: Jun. 6, 2002

(54) Electronic trading platform for agricultural commodities

(76) Inventors: Kerry Adam, Santa Maria, CA (US); Chris Corpuz, Santa Barbara, CA (US); Chris Kinnare, Encinitas, CA (US); Lee Troxler, Santa Barbara, CA (US)

Correspondence Address: STRADLING YOCCA CARLSON & RAUTH,, IP Department, 660 Newport Center Drive, Suite 1600, P.O. Box 7680, Newport Beach, CA, 92660-6441, US

(21) Appl. No.: 09/945,105

(22) Filed: Aug. 31, 2001

Related U.S. Application Data
(60) Provisional application No. 60/229,900, filed on Sep. 1, 2000.

(51) Int. Cl. G06F 17/60

(52) U.S. Cl. 705/37

(57) ABSTRACT

A first participating entities prepares a transaction offer notice on a data processing system. The transaction offer notice is stored in a database of such notices on a server system which is available to entities participating in the system. Transaction notices contained within the server system's database are available to a user community over the Internet and form the basis of a trading platform. Users are able to search the database for transaction offer notices that satisfy a set for search criteria, and are able to electronically negotiate with the offeror with respect to transaction parameters and other terms and conditions until the transaction is acceptable to both parties. The original transaction offer notice is retained in the database and is further available to the user community while negotiations are proceeding. Transaction offer notices are able to be posted by any participating entity, and once a transaction is consummate, transactions details are forwarded to a third-party financial institution for fund transfer.

### CROSS REFERENCE TO RELATED APPLICATIONS

The present application is related to and takes priority from U.S. Provisional Application Serial No. 60/229,900, entitled ELECTRONIC TRADING PLATFORM FOR AGRICULTURAL COMMODITIES, filed Sep. 1, 2000, and commonly owned with the present application, the entire contents of which are expressly incorporated herein by reference.

### FIELD OF THE INVENTION

The present invention relates generally to systems and methods for electronic trading of agricultural commodities and, more particularly, to improved data processing based systems for implementing an automated exchange for buying and selling perishable agricultural goods.

### BACKGROUND OF THE INVENTION

Agricultural commodities represent one form of goods that simply must be traded between a grower and a wholesale purchaser in order to be efficiently distributed to the ultimate consumer, in order that we all may live. Over the years, many institutions have been established which allow agricultural commodities to be bought and sold and eventually distributed, such that civilization might survive. Within these institutions, farmers have typically built their business on hand shakes and alliances, currently relying almost exclusively on the telephone and facsimile machine to transfer information relating to crop availability, quality, price, and the like. The typical agricultural sales process begins with a facsimile distribution going out to key buyers, listing particular crops to be cut or harvested and proposed prices for various lot sizes of those crops. As the process unfolds, a collection of sales persons works a telephone bank in order to contact as many buyers as possible, with the sales people talking up the product, haggling over quality, and perhaps swapping this favor for that concession, and the like.

This particular “system” has resulted in a highly fragmented and inefficient marketplace in which farmers witnessed almost a 4 to 5 percent aggregate price decrease while at the same time experiencing a 12 to 15 percent cost escalation, for an aggregate approximately 20 percent cut in compensation, during the decade of the 1990's. It is apparent that the institutions established for agricultural commodity trading in the preceding years have been highly deficient, at least from the perspective of the average farmer.

Concurrent with the observed decrease in average farm commodity prices, growers are being confronted with a multiplicity of new electronic transaction promoting schemes, such as B-to-B exchanges which introduce auction and broker business models to the agricultural produce acquisition marketplace. Each of these electronic brokering schemes has some small degree of efficiency to recommend it, but are generally configured to add more value to the buyer side of the equation than to the seller side. Increased competition in both the national and global marketplace as well as the rapid advances in technology are tending to push more and more of these electronic commodity brokerages into the forefront of agricultural trading. Farmers are not surprisingly very weary of this trend.

Notwithstanding the efficiencies that these electronic systems offer, a grower still must worry about the credit worthiness of a particular buyer and the problems associated with late payment or even non-payment of an invoice. Electronic brokerage or auction models do nothing more than post quasi-level-1 trading information, giving little to no true information to market participants regarding the true status of their marketplace. Further, reverse auctions tend to drive down prices putting further pressure on an already beleaguered group of farmers.

Auctions themselves are relatively anti-competitive, with no participant knowing how any other participant is pricing their product or what the actual scope of bidding is. Once receiving a specific bid for their crop, a farmer has no way of knowing that another participant might have made a higher bid but instead chose not to engage with that particular seller because of other circumstances. Auctions are therefore an efficient way to value commodity products, so inefficient that the regular security exchange marketplace abandoned them over a century ago and, in the shade of an apple tree on Wall Street, began a real trading exchange.

Further, local time differences and physical distance, combined with short settlement periods and the natural volatility of perishable agricultural goods, increases the risks for all of the trading participants. While the current suite of electronic trading products have reduced the risk somewhat for the buyer and/or the executing broker, by automating the confirmation process, none of these electronic trading products has provided an efficient method for promoting engagement directly between buyers and sellers in such a way that each is able to determine the full scope and content of the entire marketplace.

What is required is a system and method whereby individuals or individual institutions can buy and sell agricultural products directly between one another with only a minimal time differential and minimal risk. In such a system and in accordance with such a method, individual buyers and sellers would be in a similar position to that of a securities broker, i.e., they would have access to all of the other individual buyers or sellers wishing to purchase or sell perishable agricultural goods. In such a system an individual buyer or seller would be able to select among many competing offers to buy and sell and thus would be able to obtain a significantly better deal than would be the case under present circumstances. A farmer's biggest concern, i.e., whether or not he will get paid, should become a non-issue, with buyers entering funds into such a system's escrow account in order to cover all purchases. Having access to the entire marketplace, sellers would be able to identify “problem” buyers by their behavior so as to avoid consummating a transaction with them. Smaller growers would be able to gain access to “best practice” systems and current trading data allowing them to command higher prices. In this particular regard, the competitive bidding aspects of an efficient market mechanism should tend to increase prices for farm products in a manner quite similar to how the efficient market mechanism increases prices for securities and equities.

Developing such a system would further allow sellers to lessen or even eliminate their reliance on middlemen, such as brokers, while enabling sellers to reach a vastly larger market. Sellers would no longer be limited to selling to their co-op or to only as many people as their salespersons are able to reach on the telephone. Additionally, such a system would allow a wholesale buyer to satisfy their chief concern, i.e., being able to source product better, by giving a wholesale buyer the ability to see all of the available sellers and current market prices of the universe of selected agricultural commodities. Having such a wealth of data at their fingertips will result in enormous time-savings, thereby allowing a single buyer to accomplish the results currently requiring many, resulting in personnel efficiencies to a grocery retailer, for example.

In summary, such a system and method will provide a unique value proposition that appeals to both parties in the perishable goods marketplace. When implemented in accordance with the embodiments described herein, such systems and methods will determine how food is able to best come to market in the emerging New Economy.

### SUMMARY OF THE INVENTION

The present invention is direction to a method for effecting a transaction in agriculture commodities on a agriculture commodity exchange. The method generally includes the steps of establishing a communication network define a community of buys and seller of agricultural commodities. First multiplicity of seller asks is receive over the communication network from a plurality of selling entities, each seller ask corresponding to a particular agricultural commodity. Second multiplicity of buyer bids is received over the communication network from a plurality of buying entities, with each buyer bid corresponding to a particular agricultural commodity. The first multiplicity of seller asks and second multiplicity of buyer bids is posted to a community of buyers and sellers over the communication network in the form of level-two trading data. At least one transaction between a buyer and a seller is executed with respect to a particular agricultural commodity, by a buyer's making electronic indication on a respective posted seller ask for that particular commodity.

In a particular aspect of the invention, at least one transaction between a buyer and a seller is executed with respect to a particular agricultural commodity by a seller's making an electronic indication on a respective posted buyer bid for that particular commodity. Each respective buy bid is associated with a desire quantity index and each respective seller ask is associated with a corresponding inventory index. Changing marked conditions are accommodated by facilitating immediate electronic changes to inventory and desire quantity indices in any or all of the multiplicity of buyer bids and/or seller asks. Modified buyer bids and modified seller asks are posted in real-time to the community of buys and sellers over the communication network in the form of level-two trading data as changes are made.

In a further aspect of the invention, a system for effecting efficient electronic transactions in an agricultural market place comprises an agricultural trading platform, including a communication network linking a community of participating buyers and seller of agricultural items. The trading platform includes a server system coupled to user access devices over the communication network. A database, structured in accordance with a categorical hierarchical structure, the top-level categories to the database corresponding to top-level market subdivisions comprising the agricultural related market place, contains a plurality of transaction offer notices for agricultural items organized in accordance with a corresponding one the plurality of top-level markets. A blank set of transaction offer notices in the form of a data record defining a transaction's perimeters, each participating entity providing appropriate transaction perimeters in the data record; a plurality of completed transaction offer notices stored in the database; a search engine, hosted by the server system, the search engine searching the database transaction notices in accordance with a query corresponding to at least one transaction perimeter; and in negotiation engine, hosted by the server system, the negotiation engine facilitating an electronic transfer of a modified transaction offer notice between an originating party and a negotiating party. The system further comprises a posting engine which presents blank transaction offer notices to a participating entity and a management engine, coupled to the database, which organizes and displays a history of transaction notices originated by and transactions completed by a corresponding participating entity.

### DESCRIPTION OF THE DRAWINGS

These and other features, advantages, and exemplary modes of use will be best understood with reference to the following detailed description, appended claims and accompanying drawings wherein:

FIG. 1 is a semi-schematic partial block diagram of a network-based data processing system in accordance with practice of the principles of the present invention;

FIG. 2 is a semi-schematic, partial block diagram of a user interface portion of the network-based data processing system of FIG. 1;

FIG. 3 illustrates a more detailed block diagram of the component parts of a user interface suitable for use with the network-based data processing system of FIG. 1;

FIG. 4 is a generalized illustration of a level-2 trading screen generated by an application program hosting the agricultural commodity trading system in accordance with the invention;

FIG. 5 is a generalized illustration of a pop-up screen depicting interday price movements and trading volumes;

FIG. 6 is a generalized illustration of a further pop-up screen which might be used to define shipping and environmental cost adders to a particular purchased commodity;

FIG. 7 depicts a flow diagram illustrating the process by which a user might use the system in order to purchase a commodity;

FIG. 8 depicts a flow diagram illustrating the process by which a user might configure the system to automatically purchase desired commodities;

FIG. 9 depicts a flow diagram illustrating the methodology by which funds are transferred from a buyer's account to a seller's account.

### DETAILED DESCRIPTION OF THE INVENTION

Generally, the invention might be best understood as a system and method for implementing a true level-2 trading methodology in the context of perishable agricultural commodities, complete with streaming quotes, and real-time display of seller “asks” and buyer “bids”. In order to enhance the immediacy of this agricultural trading exchange, information is delivered to both buyers and sellers through the medium of the World Wide Web (the Internet) which defines a platform allowing information delivery direct to a buyer's or seller's computer system, without requiring the intermediary of a broker and certainly without requiring the intermediary of a centralized institutional exchange, complete with “trading pit” and institutionalized traders. In the context of the present invention, the agricultural trading exchange exists in electronic form, as an application software routine running on a centralized server system, that itself functions as the intermediary between large numbers of buyers and sellers that could be separated from one another by continental distances. Both buyers and sellers register as traders with the agricultural trading exchange according to the invention, and are able to trade from their personal computers, whether desktop, laptop or palmtop, using suitable application specific software programs based on Internet standards (HTML, XML and TCP/IP). It should be noted that the present invention is particularly suited for Wireless Application Protocol-Enabled Software in the particular case where a user might wish to maintain communication with the commodity exchange using mobile or wireless service.

To digress momentarily, WAP is an application communication protocol used to access services and information for hand held devices such as mobile phones. In order to fit within such small wireless devices, WAP makes use of a micro browser, a truncated set of software that makes minimal demands on hardware, memory and CPU time and is able to display information within a restricted mark-up language termed Wireless Mark-Up Language (WML). It should therefore be understood that the following detailed description of systems and methods in accordance with the invention, is not necessarily limited to desktop, laptop or palmtop-type computer systems, but is particularly suited for the type of device that a grower might easily be able to carry with them while working amongst the crops. Buyers and sellers, in the agricultural exchange according to the invention, are not constrained in their normal everyday movements and are not restricted in the other activities which they may wish to undertake.

A further particularly advantageous feature of the systems and methods of the present invention is that the agricultural commodity trading exchange delivers data in level-2 form, i.e., real-time bid, ask and size data from the universe of buyers and sellers participating in the exchange. Working with level-2 data allows participants to post, buy and sell orders much faster than they are currently able to and further allows participants to know where the market is going in real time. Level-2 data informs participants how many bids and offers are pending, executed and the price range amongst these. Participants are able to determine who is buying, who is selling and the size of various pending orders so as to assist them in determining where the market is and whether prices are firm or soft. In effect, working with level-2 data allows a grower to potentially sell to the highest bidder and a purchaser to buy from the lowest asker in a manner that can be likened to an aggregation of many auctions for the same item simultaneously. A further specific advantageous feature of the system and methods according to the invention relates to the trading of variable quality perishable goods. As will be described in greater detail below, both buyers and sellers are able to devise a methodology to accommodate and discount for variable quality perishable goods, deal with acts of God (inclement weather at harvest time) and interface personally. Thus, the systems and methods of the invention will be understood to describe an efficient market mechanism that will allow a buyer to source product faster and more efficiently and allow sellers to take advantage of a vastly larger market, no longer limited to selling to the co-op or to only as many people as their salesmen are able to reach on the telephone.

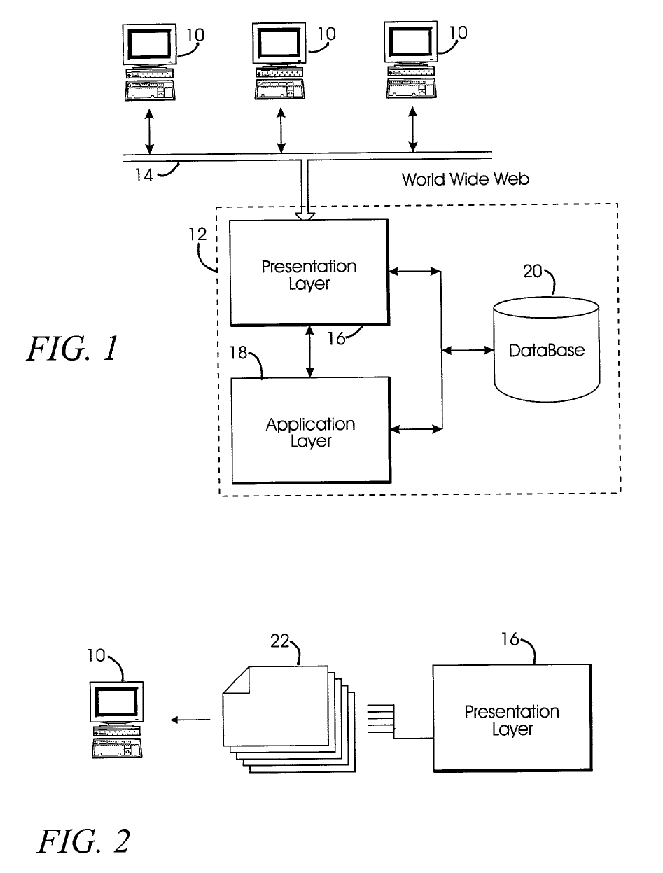

Turning now to FIG. 1, there is shown in semi-schematic partial block diagram form, the major components of a network-based data processing system, suitable for implementing the agricultural trading exchange of the present invention. As mentioned previously, the system is network-based in that a plurality of user terminal devices 10 are coupled to a central server system 12 by a network communication link 14. The network communication link 14 used to communicate with the server 12 might be implemented in the form of a number of a modem which transfers information over public telephone lines, or a cable modem, wireless communication link, fiber optic line, but preferably represents an intra-net global communication link, commonly termed the World Wide Web, itself accessible by the previously mentioned modems, cable modems, and the like. It should be noted that the specific method by which user terminal devices 10 communicate with the server system 12 is not particularly important in the context of the invention, so long as the type and scope of information which will be described in greater detail below is able to be transferred between the server system 12 and the user terminal devices 10.

It should also be noted that although only 3 user terminal devices 10 are depicted in the exemplary embodiment of FIG. 1, those having familiarity with the World Wide Web will understand that thousands, or even millions of users may connect to the server system 12 through their respective user terminal devices 10.

In accordance with the invention, the server system 12 is provided so as to allow users to buy and sell perishable goods in the form of agricultural commodities from one another, as well as to allow for the management of this trading activity and of the trading network as a whole. For example, when a wholesale buyer forms a bid order for a particular commodity, this order is transferred from the buyer's terminal device to the server system 12 through a presentation layer 16, implemented as a set of user accessible screens having data entry and data delivery fields arranged in such a fashion so as to ease trading activity. The wholesale buyer's bid order is processed by an application layer 18, implemented as an application software routine, and which functions, in a manner to be described in greater detail below, as the central trading engine of the invention. Application layer 18 processes the bid and posts it, again through the presentation layer 16 to a level-2 data screen which is accessible by all of the user's registered with the exchange.

In like manner, a produce grower develops an ask order for particular commodities which he wishes to sell, and transfers the ask order over the communication link 14 to the server system's application layer 18 through a corresponding data entry screen provided by the presentation layer 16. The ask order (commodity price and quantity being sold) is then processed by the application layer 18 and posted to a level-2 trading screen implemented through the presentation layer 16 whence it is accessible to all of the users registered with the agricultural commodity trading exchange.

In addition to presentation and application layers, the system of the invention further includes a database 20 which might be implemented as a monolithic data base, or might also be implemented as a multiplicity of smaller, case-specific databases, for data storage and retrieval. Data base 20 is particularly suitable for developing and maintaining statistical data regarding pricing trends, market movement parameters, the effects of weather and various demographic pressures on both supply and demand, all of which would be made available to registered buyers, registered sellers and registered market analysts, in order that such trend data might make the market more efficient on a long-term basis.

In like manner to the user terminal devices 10, the server 12 is depicted in the exemplary embodiment of FIG. 1, as a single device, but need not be so implemented. The server 12 might be composed of several computing units which might typically contain external storage units, communication interfaces for transferring data between and among users as well as the other servers, processors and memory subsystems and other computing devices that are commonly attached to servers. In addition, a number of servers might be distributed in different geographical locations, with each server forming a local nexus for a local agricultural commodity market, in order to make such local markets more efficient. The advantages of a distributed server system become apparent when it is recognized that buyers and sellers are able to participate on a continental basis, with sellers in for example California and Connecticut both marketing their produce to a universe of wholesale purchasers that might include buyers in Alaska, Canada and Texas. Local distributed servers allow the agricultural commodity trading exchange to be implemented in a quasi-star configuration, with each nexus communicating with all others so as to aggregate all of the data, allow for cross-country purchases and shipments, while more directly servicing local agricultural markets.

Turning now to FIG. 2, there is illustrated in semi-schematic partial block diagram form, a detail of how the system's presentation layer 16 might interact with a particular user interface terminal device 10. Briefly, the presentation layer 16 is composed of a number of particular, purpose-built graphic display screens, generally indicated at 22, each of which are particularly devised to either present or receive application specific data. The presentation layer 16 is implemented as a number of graphic screens 22 since the presentation layer must be able to communicate with both buyers and sellers, as well as be able to present trading data to the entire universe of users. The graphical display screens 22 are necessarily controlled by a display engine within the presentation layer 16 which invokes particular ones of the display screens depending on individualized choices of a particular user. Since the system is contemplated as being Internet based, one of the screens, i.e., an entry screen or a top-level screen, might be the trading exchange's home page, from whence a user might navigate through the system in an efficient manner. Other pages might be individualized for displaying or receiving buyer specific data, such as desired prices and quantities for particular types of commodities (bids), while other pages might be individualized for a seller's purposes, such as presenting or receiving data regarding a sales price and quantity (an ask). A further screen or set of screens is not particularly individualized for either a buyer or a seller, but might rather be directed towards presenting or receiving data relating to an aggregate or universe of trading transactions, and specifically, for presenting such information in the form of level-2 trading data.

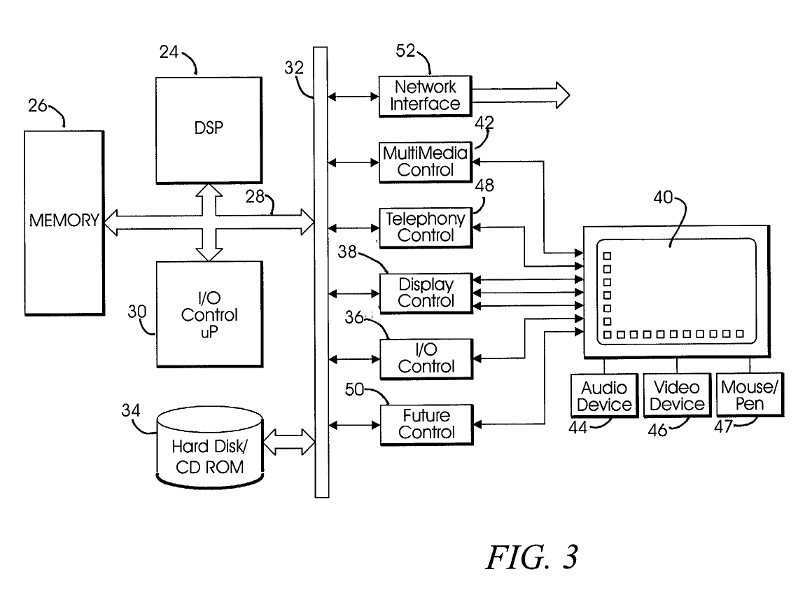

Before discussing the operational details of the systems and methods of the present invention, it would be useful to describe the type or types of user interface devices (10 of FIGS. 1 and 2) that are particularly suited to interface with the exemplary agricultural commodity trading exchange system. A generalized, block level diagram of such a user interface system is illustrated in FIG. 3 and is illustrated generally at 10. The user interface device 10 is configured as a desktop or laptop-type personal computer system and is capable of executing an application software routine, such as a net browser program, as well as incorporating various I/O interface devices so as to be able to communicate in accordance with whatever communication link is established between the user device 10 and the exemplary system's server (12 of FIG. 1). The user device 10 suitably includes a control processor 24 which might be a digital signal processor, a commercial general purpose microprocessor or a purpose-built processor, capable of executing instructions provided as an application software routine. The system 10 further includes memory 26, such as RAM, ROM, EEPROM, and the like which functions to store the system's operational programming as well as providing temporary storage for data being transferred to and/or from a network server system. The microprocessor 24 and memory 26 are coupled together over an internal bus 28 which is further coupled to an I/O control processor 30 which operates the various interface and peripheral devices which enable the system 10 to communicate with the outside world.

Thus, the processor 24 fetches, decodes and executes computer readable instructions and transfers information between other system resources over the main system bus 28 and a peripheral bus 32. Peripheral bus 32 typically interconnects the various peripheral components in a data processing system and further defines the particular protocol for data exchange. An example of such a bus is the Peripheral Component Interconnect (PCI) bus.

A hard disk drive or CD ROM drive 34 is often coupled to the system over peripheral bus 32 and offer the system the capability of large-scale data storage. Access to the hard disk/CD ROM drive 34 may be controlled by an I/O control circuit 36 that directs and controls reading information from and writing information to any of the various storage media that might be implemented within the system. In addition to I/O control 36, the system might further include a display control circuit 38 (i.e., a video card) that determines how information is arranged on a visual display screen 40. A multimedia controller 42 might also be coupled between the peripheral bus 32 and a systems display 40 in order to give the material being presented to a user the added dimensions of sound and motion. In this regard, an audio device, or devices, 44 might be coupled to the system in parallel with the system display 40. The audio device 44 might be implemented as a combination of a microphone and speakers, such that it can receive an audio input from the user through the microphone and deliver audio content to the user over the speakers. A video device 46 might be implemented as a camera which receives moving visual images from the user which are subsequently processed by the multimedia controller 42 for transmission over the network, for example.

The multimedia controller, in combination with the microphone and speaker system comprising the audio device 44 and the camera comprising the video device 46 gives the system 10 capability of real-time multimedia communication between and among various users of the trading exchange. In a manner to be described in greater detail below, buyers and sellers may invoke face to-face audio visual communication if it is deemed desirable to engage in negotiations over a particular transaction.

In keeping with this communication capability, the system might further include a telephony controller 48, which might be implemented as a Voice Over IP (VOIP) interface circuit for implementing telephonic communication over the Internet, or it might be implemented simply as a local POTS or PBX telephonic interface circuit. In this regard, telephony control 48 and multimedia control 42 are not necessarily mutually exclusive operational modes. Depending on how a user is using the system 10, bandwidth constraints might require that the user effect communications using a telephony application at certain times while the availability of a high bandwidth network connection may allow the user to engage in multimedia communication modes at other times. Having both communication modalities available in a particular device, while not necessary for practice of the present invention, would be advantageous to users whose livelihood depends on maintaining at least a modicum of communication with the trading exchange during peak trading seasons.

Because the system 10 is implemented as a personal computer (whether desktop, laptop, palm top or the like) it will be evident to those having skill in the art that other interface and/or communication methodologies may be incorporated into the system, on a modular basis, as those communication methodologies are developed and commercialized. For example, as wireless technology becomes more pervasive it is certainly expected that it will be incorporated into the next generation of computer systems. Accordingly, a future interface controller 50 is expressly incorporated into the exemplary system 10 and is contemplated as supporting any one of a number of future communication/interface modalities.

Any or all of the aforementioned communication/interface control devices are easily coupled to a modem computer system through its peripheral bus 32 as expansion cards or boards. Typically, an expansion card or board comprises a circuit board hosting integrated circuit chips and other electronic components that adds functionality or resources to a computer system in expandable fashion. For laptop, palmtop and/or other portable computers, expansion cards typically take the form of PC cards, which are credit card-size devices designed to plug into a slot or receptacle provided for such purpose on the side or back of such a computer system. A particular example of such an expansion card is the PCMCIA (Personal Computer Memory Card International Association) card.

In order for the system 10 to communicate with a server or servers implementing the trading exchange, a network interface device 52 is provided and which is also coupled to the peripheral bus 32. Network interface device 52 allows the system 10 to communicate with other devices coupled to a particular network in accordance with that particular network's information exchange protocol. For example, the network interface device 52 might be a 100 BASE-T Ethernet transceiver, if the physical communication media between devices were an unshielded twisted pair wiring plant. Alternatively, the network interface device 52 might implement wireless communication protocol such as Bluetooth, might implement cable modem circuitry, and the like. It should therefore be understood that the specific form and functionality of the network interface device 52 is not particularly important to the scope and spirit of the invention. All that is required is that a user system 10 have some means of accessing and communicating with a server or servers hosting the agricultural trading exchange, over some form of local or wide area network, such as the World Wide Web.

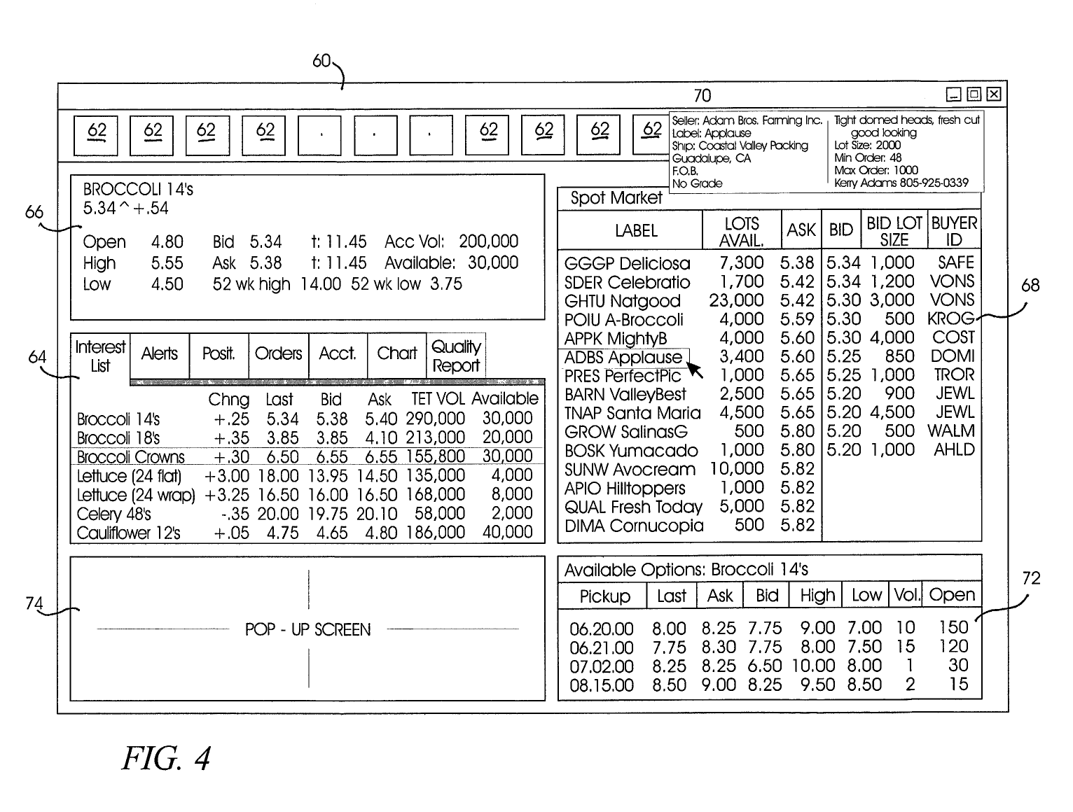

The operation of the agricultural commodity trading exchange, in accordance with practice of principles of the invention, will now be described with reference to FIG. 4, which illustrates an exemplary trading screen such as might be seen by registered buyers and sellers, and which graphically presents the scope of an agricultural commodity market in level-2 form. The principles of the trading methodology of the present invention will be described in connection with the exemplary trading screen of FIG. 4, but it should be understood that each of the features, aspects and advantages of the system, as illustrated in the context of the screen of FIG. 4, are processed, packaged, and presented by corresponding application software routines residing in the system's central server system (or systems) and comprising the application layer that defines the agricultural exchange.

Turning now to FIG. 4, the data is processed and arranged for graphical display in a concatenated set of windows and sub-windows of the type suitable for expression as web pages in an exemplary web browser-type local application residing on a user's interface device. As such, the exemplary trading screen of FIG. 4 is provided with a menu button bar 60 which functions to host and support a multiplicity of function buttons 62, each of which serve to access and invoke various functional systems and subsystems which comprise the application package, in conventional fashion which will be well understood by those having skill in the art. In this regard, it is worth noting that the particular application shell which provides the various tool bars, menu button bars, and the like, might preferably reside on each user's interface system as an application program. Alternatively, a user's system need only be able to support a web browser application, or some truncated form of web browser, such as a mini browser, in the case of a hand-held wireless system, with the various aspects of system functionality being provided as a shell by the trading system's application and/or presentation layer.

Regardless where hosted and how presented, the various menu option buttons 62 allow a user to invoke, access and use the various pieces of individualized functionality that is provided by the agricultural commodity trading system according to the invention. Pertinent ones of these are depicted in the exemplary trading screen of FIG. 4 as sub-windows, each of which are individually configured to provide data to a user relating to specific aspects of the overall nature of agricultural commodity trading. In particular, the sub-screens include an individualized activity screen 64 which might be further subdivided into particular pages, each of which are pertinent to a particular user's trading activity. In the example of FIG. 4, the activity screen 64 is shown as displaying a particular user's interest list and which is configured to give a listing of the various agricultural commodities that a particular user might be concerned with. For example, in the exemplary interest list, the user has configured the page to show the trading parameters and availability metrics of three different forms of broccoli, broccoli 14's, broccoli 18's, and broccoli crowns. In addition, two forms of lettuce are of interest to the buyer, 24 flat and 24 wrap, as well as celery 48's and cauliflower 12's.

Arranged against the various commodities are (from right to left in the exemplary interest list) the availability figures for each of the commodities, the total volume of each commodity that might be available, the asking price, the bid price, the price at which the last trade was executed and a change or trend metric indicating the direction in which the price is moving. Both buyers and sellers are able to post additional commodities, or particular selected commodities, to their interest list by accessing perhaps one of the menu button bars 62 which would activate a pop-up screen which shows all of the different agricultural commodities available for trading through the exchange in alphabetical order. A user need only use a pointing device, such as a mouse, in order to drag-and-drop a particular commodity, such as broccoli crowns, from the commodity list to the interest list of the activity window 64.

Additionally, commodities may be removed from the interest list by perhaps right clicking with the mouse and selecting “delete” from a pop-up menu that appears in conventional fashion. Thus, it should be understood that any user, whether buyer or seller, is able to build an interest list that contains only those commodities in which they have a particular interest. Thus the page is termed the interest list.

Additional pages that are available through the activity window 64 include an alert page through which a user is able to structure a list of commodities that they are interested in trading. In the case of a wholesale buyer, the structured list might be a list of those commodities which they are interested in purchasing at a particular price or which might be available in a particular quantity. For example, if a wholesale buyer is interested in making a purchase of a large lot size of broccoli 14's at a price of $5.25, for example, and the asking price is $5.40, the buyer might structure his alert page to give him a notification whenever an “ask” order is posted which has a price in the general neighborhood of $5.25. Alerts may be set up to bracket a price, for example, i.e., between $5.15 and $5.35, or set a trigger threshold, i.e., less than $5.35, or even provide an alert on the basis of a price trend metric such as 2 or 3 trades in a row with increasing or decreasing prices. Further, as will be explained in greater detail below, a user may request an alert when a particular buyer or seller enters the market with a particular commodity. Since many buyers and sellers have long-standing relationships, a wholesale buyer for Kroger Foods, for example, may wish to receive an alert when broccoli crowns are offered by Adam Brothers Farming, Inc., for example.

A further page within the activity screen 64 is a position page, containing a list of a user's (whether buyer or seller) position in the market with respect to their various interested commodities. Likewise, an order page might contain a list of all of the orders placed by a user, in the case of a buyer, or all of the order's taken, in the case of a grower. An account page is able to give an immediately synopsis of the status of a user's account with the trading exchange, while a chart page allows a user to graphically represent the various trends obtaining over time in a dynamic trading market.

A quality report page allows a wholesale buyer, for example, to receive intelligence about the quality status of the various commodities. Crop availability and quality reporting are currently available in the agricultural marketplace and need only be collected by the trading exchange and made available to users through the quality report page. Accordingly, the system is able to collect and correlate a large amount of crop availability and quality data from a large variety of sources and make it available to a user in a standardized format, accessible with the single click of a mouse. Buyers and sellers no longer need to access and consult a multiplicity of data sources, in both print and electronic form, in order to receive up-to-date crop information.

Returning to the interest list of the activity window 64, additional information can be obtained with respect to particular commodities by selecting a chosen commodity with a mouse, for example, and clicking on that commodity, which opens a commodity report window 66, configured to give the complete set of trading statistics available for the particular commodity selected from the interest list of the activity window 64. In the example of FIG. 4, the user has chosen to view the trading statistics available for broccoli 14's which are accordingly highlighted in the interest list. The commodity report window 66 identifies the commodity (broccoli 14's) as well as the last trade price, a trend indicator (up or down) as well as the last price change data. Also available in the commodity report window 66 are price and availability statistics which indicate the opening price for the chosen commodity, the high and low at the current time, the best current bid price as well as the lowest current ask price. Further information that might be available in the commodity report window 66 would include the yearly high and/or the yearly low for that commodity on a 52 week rolling scale. Accordingly, a buyer or seller is able to obtain a good snapshot of current market conditions for a particular commodity, as well as being able to put that snapshot into a long-term context.

It is worth mentioning that each of the particular commodities disposed on a user's interest list generate their own commodity report statistics whenever they are selected by a user for detailed viewing. It should also be mentioned that any one of the universe of commodities offered through the trading exchange of the invention can also have its detailed trading statistics reported in the commodity report window 66 by merely accessing the appropriate menu button 62 which opens the pop-up window containing the entire list of commodities and selecting the desired commodity by way of a mouse click. Thus, any of the commodities that the exchange has posted in its universe list is able to generate a set of trading statistics in the commodity report window 66 regardless of whether a user has moved that commodity to their interest list or not.

Further, and in accordance with the present invention, a user is able to develop spot market statistics for any of the commodities available for trading through the exchange. A spot market report window 68 gives an indication of all of the registered buyers and sellers of any one particular commodity, or a pre-selected subset of buyers and sellers, along with each of their respective bid prices (in the case of buyers), ask prices (in the cases of sellers), the number of lots of the commodity available and the lot size requested for each bid. Sellers are identified by label, in a manner very similar to the symbolic representation of particular stocks on the New York Stock Exchange, NASDAQ, etc. Likewise, buyers are identified by a code (a 4 letter code in the exemplary embodiment of FIG. 4) which is understandable to the market participants.

Spot market participants are arranged in order of increasing ask price, in the case of sellers, and decreasing bid price, in the case of buyers, so that buyers and sellers may respectively judge their particular positions with respect to their counterparts in the market. In the exemplary embodiment of FIG. 4, the spot market window 68 illustrates the currently active buyers and sellers of broccoli 14's and further indicates that a particular seller, GGGP having a trade label Deliciosa, is offering 7,300 lots of broccoli 14's at a price of $5.38 per lot. The asking price increases, going down the list, until at the bottom, one is able to discern 4 sellers that are offering a total of $16,500 lots of broccoli 14's at an ask price of $5.82. On the buyer side, the spot market window 68 indicates that 2 buyers, Safeway and Vons, are together interested in purchasing 2,200 lots of broccoli 14's at a price of $5.34. The bid price decreases down the list until one can see that 4 buyers are interested in obtaining 6,900 lots of broccoli 14's at a price of $5.20.

Evaluating the spot market statistics of broccoli 14's, for example, can indicate to both buyers and sellers the form that the market is currently in and can also give buyers and sellers certain information as to its likely trend. In the example of FIG. 4, there is a significant number of broccoli 14 lots available at asking prices ranging from $5.38 to $5.42 per lot. Because of the large availability of produce at the generally lower prices, it is unlikely that the 4 sellers asking $5.82 per lot will be moving their produce in the relatively near future, particularly when availability at the lower price is certainly able to meet the total demand on the bid side.

A data burst pop-up window 70 provides certain crucial data relating to both buyers and sellers that would be of extreme interest to the other participants in the spot market. The data burst window 70 is activated by a mouse-over movement of the mouse pointer over any one of the listed buyers and/or sellers in the spot market window 68. As indicated in the example of FIG. 4, the mouse pointer has indicated the seller ADBS Applause, activating the data burst pop-up window 70 which now contains information relating to the seller's identity, the label under which that particular commodity might be marketed by the seller, crop quality information, contact information and other crucial data that assists in facilitating open-market trading of variable-quality perishable items. The data burst pop-up window 70 might also contain information relating to the seller's shipper of choice as well as data on the size of the crop available to the seller, and the maximum and minimum order quantities.

Similar types of information also available for buyers in a data burst pop-up window, but might contain creditworthiness information as opposed to crop availability and quality metrics in the case of a seller. Thus, a wholesale buyer might wish to interrogate the GGGP Deliciosa seller in order to ascertain whether the relatively lower asking price is the result of lower quality goods or if the seller might be in a sufficiently remote geographical location such that increased shipping costs must be incurred in order to obtain the product. Similarly, sellers may wish to ascertain whether a buyer who has posted a relatively higher bid price is a chronically slow payer, such that the buyer might make up the price differential in interest float. It should therefore be understood that a great deal of crucial data may be packed into the data burst pop-up window 70, access to which would greatly facilitate trading decisions with respect to perishable agricultural commodities. Since this data is available to all participants in the trading exchange, and is easily accessible by simple mouse-over techniques, buyers and sellers are no longer able to “hide-the-ball” so to speak with respect to crop availability and quality, on the one hand, and the financial details of the transaction, on the other.

A further advantageous feature of the present invention is its ability to support option trading and commodities. A commodity option screen 72 indicates the various options available for a particular chosen commodity (broccoli 14's in the exemplary embodiment of FIG. 4) with substantially the same forms of price and availability metrics shown in the previous examples. The option screen 72 indicates the timing available for each option exercise by use of a pick-up date list for each entry. Each entry further includes both the best bid and lowest asking prices, the high and low for each entry, the last transaction price, the volume traded and the number of options remaining open. Thus, a wholesale buyer, for example, might choose to trade on the options market rather than the spot market, if delivery timing is not an issue and the buying entity is not in immediate need of the desired commodity.

A further pop-up screen 74 is available in the trading window and is reserved for displaying any one of a number of different optional pop-up screens accessible through the various menu buttons 62 of the menu bar 60. Such additional pop-up menus 74 might include individualized data entry windows through which a buyer might enter a buy order, a seller might post an ask order or by which buyers or sellers might review account activity, trend activity, or might analyze the total net cost of a given transaction, complete with all ancillary costs associated with the purchase, shipment and receipt of an agricultural commodity.

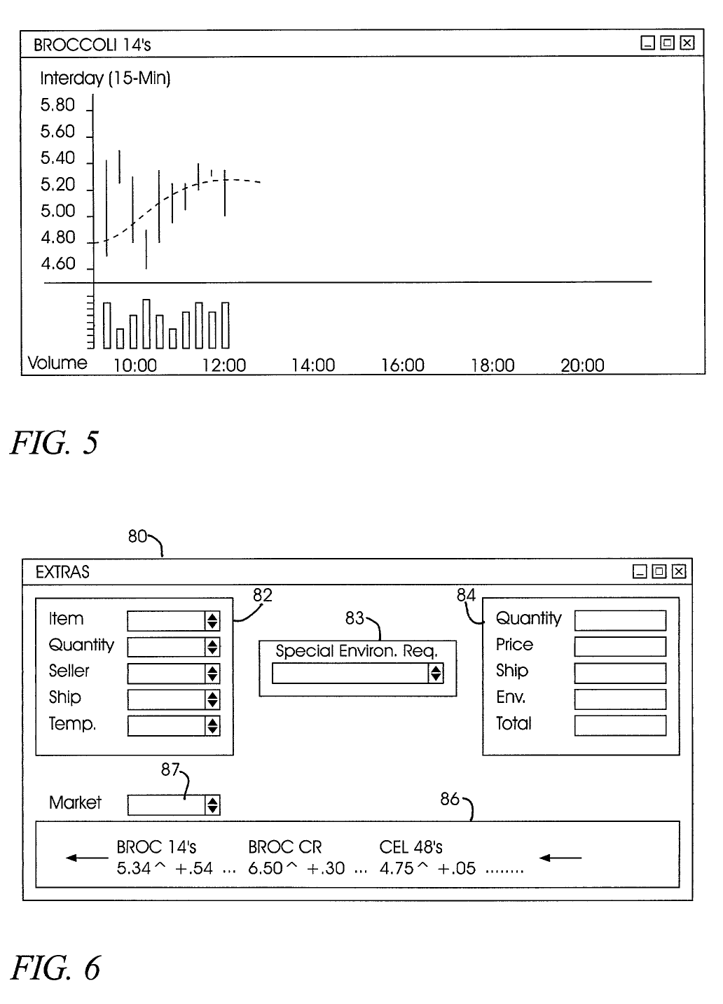

Turning now to FIG. 5, one of the trading metrics that might be of interest to a participant in the commodity exchange might be the interday trading activity in a particular commodity. An exemplary interday trading graphic is depicted in the illustrated embodiment of FIG. 5 such as it might appear in the reserved pop-up window 74 of the main trading screen. The interday trading graphic depicts the movement and spread of trading activity in broccoli 14's, in 15 minute intervals from the start of the trading day until the current time hack. Interval spreads are given for each time interval, to indicate the high and low price activity during that interval. Further, a statistical trend line may be superposed over the data in order to show the movement of the average trading price over the course of a particular trading day.

Data posted on the interday activity window is collected from the trading exchange's database of all executed trades and statistically processed for posting in the activity window. This kind of information is extremely valuable to buyers and sellers, as it gives an indication of price trends throughout the day. If, for example, the trade price tended to be depressed during the afternoon hours, a wholesale buyer would be willing to take advantage of this information and execute their purchases in the afternoon. Likewise, sellers might wish to get the best possible price that they could in the morning hours, knowing that the interday trend leads to lower prices in the afternoon.

In addition to interday pricing activity, the volumes for each interval are also posted, in bar graph form, in order that a user might better evaluate the pricing statistics. If, for example, a relatively high posted price was for a relatively small volume, users might evaluate that statistic as representing merely a quantity artifact, as opposed to a true price trend. Further, evaluating volume statistics in combination with price statistics would enable a user to recognize whether afternoon price depressions were the result of large daily unloadings or merely the result of odd-lot transactions, with the majority of trading activity taking place in the morning hours. The ability to obtain, view and analyze such statistics, in real time, during the course of trading, provides further crucial information to buyers and sellers of perishable agricultural commodities. Making all of this information, including quality, volume, price, and credit statistics, available to participants in the commodity exchange in one place, on a real time basis, allows for the participants to develop, establish and maintain an efficient market for perishable commodities. Thus, participants in the agricultural exchange, according to the invention, are able to have access to information of a scope and quantity heretofore unrealized in the agricultural marketplace. Access to such information necessarily leads to better and more stable prices, and allows the market to efficiently operate so as to allocate more appropriate prices to respective ones of variable quality goods.

Trades (posting both buy and sell orders) are executed in a manner which will be described in greater detail below, but once a particular commodity has been selected for purchase, a wholesale buyer might be very interested in the total cost of a particular transaction, including such ancillary items and extras as shipping costs and environment conditioning costs (refrigeration and/or blown-in ice). This information is available through the reserved pop-up window (74 of FIG. 4) by executing the appropriate menu button 62 from the main screen's button bar 60. In FIG. 6, there is depicted an exemplary extras window 80 through which a buyer might indicate what sorts of extra costs would be incurred for a particular commodity shipment. A user would indicate the particular item purchased, and the quantity, along with an indication of the seller and a preferred shipping company. As is well understood by those having skill in the art, the various shipping rates are well known throughout the agricultural commodity community and need only be posted to the trading exchange's database. The buyer's receiving location is typically known as is the seller's loading dock, FOB points and the like. The freight charges can be easily calculated with this information and added to the purchase price of the commodity. In addition, a buyer might indicate whether special environment conditions are required, such as refrigeration, ice, and the like, the particular costs of which are also well known and are also posted to the trading exchange's database. These costs are then added to the transaction and shipping costs in order to develop a total cost for the entire transaction.

In the exemplary embodiment of FIG. 6, identification and requirement metrics are set up through a series of selectable drop-down menus 82 from which a user selects appropriate ones of an item, quantity, seller ID, shipper, etc. Special environmental requirements might be selected from a drop-down menu 83. Based upon a user's selections from the various menus, the total price is developed in a set of data reporting fields 84 which might indicate the item quantity, item price, shipping costs, the costs for any special environment requirements, and the like. The sum of these individual costs is displayed as a total transaction price.

It should be noted that the extras window 80 of FIG. 6 is merely an exemplary embodiment of how ancillary costs might be added to the transaction cost associated with the purchase of a particular commodity. The data entry and reporting fields need not be arranged in the same manner nor need certain of the data entry and reporting fields even appear. The extras window 80 serves only to illustrate how some of the ancillary costs associated with the transaction might be accounted for and added to the transaction price in order to develop a total cost to a wholesale purchaser. All that is required, in accordance with the present invention, is that some means exist for ancillary costs to be specifically identified to each transaction and that those ancillary costs and the transaction costs are totalized to reflect the true price of a commodity at a purchaser's receiving dock. This process is relatively straight forward given that the individualized costs are relatively well known, are included in the trading exchange's database and are available for regular arithmetic processing and display upon request to a registered user.

In addition to the “extras” data entry and reporting fields, the extras window 80 also depicts a streaming quote ticker 86 which is user configurable to receive dynamic updates of commodity prices from the agricultural exchange of the invention, as well as prices from other exchanges such as CME, NASDAQ, and the like. The content of the streaming quote sticker 86 depends on the particular market chosen which is, in turn, selected by a market selection drop-down menu 87 which contains all of the available markets from which ticker information is available.

It should further be understood that although the streaming quote ticker 86 is depicted as part of the extras window 80, this particular feature may be implemented anywhere throughout any of the windows (pop-up or otherwise) presented to the user through the trading exchange's presentation layer. The streaming quote ticker 86 is depicted as part of the extras window 80 for purposes of convenience and ease of description only, and is not intended as an indication of where this particular functionality might be implemented.

Notwithstanding the exemplary embodiments of FIGS. 5 and 6, the reserved pop-up window, 74 of FIG. 4, can present a great deal of additional information, when a user selects the appropriate button bar 62. For example, if a buyer clicks on broccoli, they might have a choice of several crucial technical charts with regard to that commodity. One of those technical charts might include the interday price movement discussed in connection with FIG. 5, while the other might pertain to crop availability projections. A further pop-up screen might pertain to order confirmation, through which a buyer might receive an e-mail confirmation that his trading account has been debited once the buyer fills an order, and that the funds have been transferred to an escrow account. A seller might receive e-mail confirmation that a certain quantity of goods have been purchased at a certain price and authorizing release of the product to the shipper. When the trucker delivers the order and it is received and accepted by the buyer, a seller might receive a further confirmation e-mail stating that the funds which the buyer has placed in escrow have now been released to the seller, thereby closing the entire transaction.

A further pop-up window might pertain to a participant's account activity and give participants complete access to an on-line accounting system.

Returning momentarily to the exemplary embodiment of FIG. 4, a further advantageous feature of the trading exchange in accordance with the invention is its ability to allow buyers and sellers to establish data filters through which spot market reports, for example, can be individualized. Certain forms of data filters can be set up by buyers or sellers in order to have the system display a truncated set of corresponding seller and buyer participants within a particular market for a particular commodity. The utility of this particular feature becomes apparent when it is realized that a certain subset of buyers, within the universe of buyers, might have a history of being “troublesome” with regard to payment schedules, quality complaints, and the like. Likewise, certain sellers may be recognized by the community as occasionally representing their goods as being of a slightly higher quality than is truly the case. Additionally, certain buyers, or their parent institutions, might have long term relationships with a particular set or subset of growers which the wholesale buyer might wish to maintain.

Each and every one of these data filters might be established by accessing a data filter window in the reserved pop-up window 74 by depressing a corresponding button bar 62. Once the filter window comes up, a buyer or seller is able to establish either an “exclude” or “include” list of respective sellers and buyers that will form the basis for their spot market report. Buyers might be able to note “troublesome” sellers or sellers whose produce would incur larger than normal shipping costs due to geographical displacement, on their “exclude” list, while pre-selecting long term partners on an “include” list. Similarly, a seller could “exclude” the codes of known “troublesome” buyers, leaving only acceptable buyers and their bids on the bid side of the spot report.

Accordingly, it will be understood that the agricultural commodity trading exchange in accordance with the invention, represents a unique software application that is delivered over a web browser interface to a community of registered buyers and sellers, thereby assuring easy access by every potential buyer and seller. Its generalized structure includes a full level-2 trading exchange medium supported by pertinent data presentation windows, residing within a personalized user interface. The system further promotes and implements a personalized set of user configurable reporting and charting windows that give the agricultural commodity community access to third party evaluations of crops in the field (birddog reports), and experience ratings by which buyers and sellers are able to grade one another. Historical trading statistics are acquired and processed and texturally and graphically displayed to users so as to add a substantial degree of richness to the quantity and quality of information available as to the marketplace. Because of its inherent modularity, additional features can be easily added as necessary to build or enhance portal functionality. Such additional features would certainly include futures tickers, real-time weather reports directed to crop producing regions, access to discussion groups, bulletin boards, financial planning sites, and the like.

Further, all elements of an agricultural commodity purchase transaction, from development of purchase orders, invoicing, preparation of bills of lading and payment, are performed electronically, with an audit trail. Transaction records are maintained, on a confidential basis, within the exchange's database and are auto-archived for future reference. Although not strictly necessary for implementing a trading exchange, transaction security can be maintained by establishing a 128-bit encryption algorithm as an I/O filter between a user and the exchange's server system.

In operation, buyers and sellers registered with the system, host their own bid and/or ask orders through their respective personalized user interfaces with the exchange's server system. In the case of a buyer, a buyer would fill out an electronic order form that would include, for example, the specific item (i.e., broccoli 14's), the bid lot size desired and a bid price. This activity may be undertaken at any time the buyer is connected to the system and may therefore be undertaken before or after the buyer had an opportunity to review the daily trading statistics.

Likewise, sellers offering produce would enter the item description (broccoli 14's), the number of lots available of that commodity, a price/quantity matrix (i.e., 50-1,000 lots at $5.25, 1,000 to 5,000 lots at $5.15, and the like) and a quality index. Trading slips available to buyers and/or sellers can be accessed through the reserved pop-up window by pushing the appropriate button bar as described above. The buyer would push the “bid” button and a “bid slip” would appear in the reserve pop-up window space. The buyer fills out the bid slip and forwards the bid slip to the trading exchange where it is posted as an active bid. Sellers would depress the “ask” button which invokes an “ask slip” in the reserve pop-up window space. The seller fills out the ask slip and forwards it to the trading exchange's server system for posting as an active offer for sale of a particular commodity. The trading exchange time stamps each of the received bid and ask slips and immediately formats the information contained therein for real-time posting to the trading screen. Buyer IDs are associated with bid lot sizes and bid prices and inserted into the spot market window, for example, in an appropriate location depending on the magnitude of the bid price with respect to the other bid prices already posted. Similarly, ask slips are processed and a seller ID and label is associated with lot availability data and an ask price, and the resulting data fields inserted into the spot market window, for example, in an appropriate location depending on the magnitude of the ask price with respect to the rest of the already posted ask prices. The trading statistics are automatically extracted from bid and ask slips and forwarded to the exchange's database for statistical processing and inclusion in interday pricing trend graphs, volume fluctuation indices, and the like.

Further, crop availability reports, quality birddog reports, buyer and seller ratings and other forms of pertinent data are electronically received by the exchange's server system and the information contained therein is aggregated and formatted by an engine comprising the system's application layer into reports accessible to the user through the system's presentation layer. User databases, from Excel to flat files, are also able to be cleansed and normalized into uniform XML format for streamline data entry and system integration.

Once a buyer or seller has posted their bid or ask slips, they may wish to begin evaluating the data contained on the trading screen in order to either make a purchase or to modify their bid or ask prices or quantities to better conform with market imperatives.

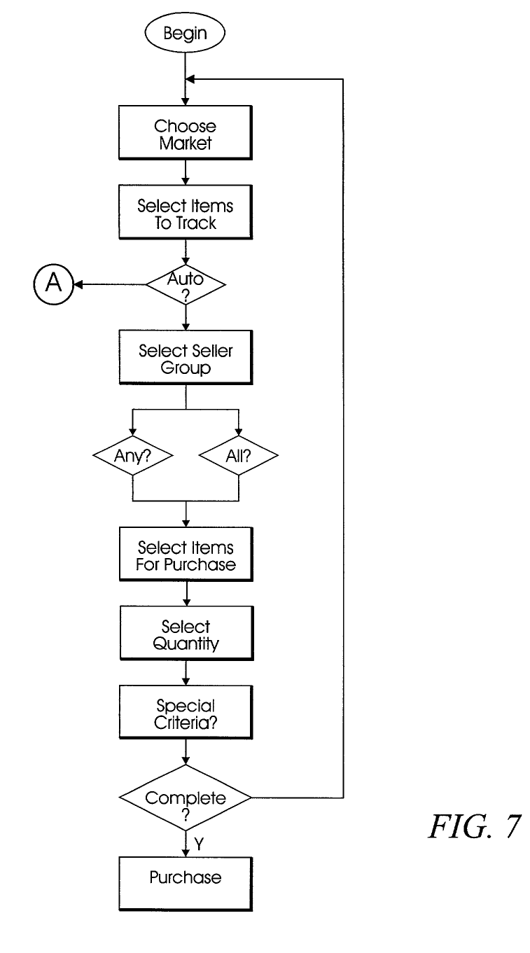

An exemplary process by which a wholesale buyer might make a particular commodity purchase will now be described in connection with the exemplary process flow diagram of FIG. 7. Naturally, a buyer would choose the market in which they wish to participate, such as the spot market or the futures market and once the data comes up for that particular market, the typical wholesale buyer would then select the various items that they wish to track, typically adding them to their interest list page. At this point, a buyer might wish to have their personalized interface automatically review the available commodity offers against a set of established criteria and, once the criteria are met to automatically place a purchase order against that item. Selection of the automatic option is indicated by the “A” branch of the process flow of FIG. 7 and will be described in greater detail below. Assuming that the buyer does not wish to automatically effect purchases, but would rather participate in the process manually, the buyer might then establish an “include” or “exclude” filter for the spot market report. If a filter is elected, the buyer can include or exclude any of a set of sellers on the basis of any set of inclusion or exclusion parameters that the buyer deems appropriate. If a selection filter is not established, the system defaults to listing all active sellers of the selected items, along with their quantity and price metrics.

Alternatively, a buyer might only be interested in suppliers located in his particular tri-state area, for example, and might have previously set his filters so that these are the only sellers that appear on his personalized interface. The buyer might then click on the commodities that he needs to purchase that day and might then drag those commodities to his interest list. In other words, items might be selected first and filters established later, or conversely, filters might be established through an initial profile that informs data I/O during initialization and sign-on. The order of the particular steps is not important, only that the functionality is provided by the system.

After set up, the buyer is now able to focus on the items that he needs to purchase. If the buyer likes the present state of the market, he may commit right away: if he sees that there are only 1,000 cartons of raspberries left for purchase, he may wish to purchase quickly in order to get the quantity that he requires. Alternatively, the buyer may request than an audible alarm be set in order to obtain notification when a particular price target is hit such that the buyer is able to focus on trading for a different commodity at that moment in time.

Once a decision is made, the buyer selects items for purchase by highlighting a particular item and either by manipulating the mouse buttons or by clicking on a “purchase” button bar, indicating a desire to obtain a certain quantity of the selected goods. Once a particular item is selected, buyer must then enter the quantity desired. The buyer's bid lot size for that particular item is the default quantity, but as those having skill in the art will immediately recognize, one's desires do not necessarily correspond with marketplace realities. Thus, the quantity available for a particular commodity might not reach the buyer's desired bid lot, forcing the buyer to manually enter a smaller value in a quantity field. If a Florida buyer is interested in purchasing California avocados, for example, there might be special environmental requirements (refrigeration and/or temperature probes) that must be added onto the cost of obtaining the commodity. Accordingly, the buyer indicates any special criteria that must be added to the straight-up transaction costs.

Having made this particular purchase (avocados, for example) the buyer either continues the commodity tracking and selection steps or proceeds directly to the purchase step where the buyer's purchase order is registered in the system as a transaction.

In terms of system internal operation, the commodity item, price and quantity metrics are extracted from the purchase order and processed in the system's database for posting as a current trade. Since the system has access to the buyer and seller IDs, both the buyer's itemized bid statistics and the seller's itemized ask statistics are processed to reflect the just included purchase transaction. If the buyer was able to obtain all of his quantity requirements for a particular commodity, that buyer entry is deleted from the spot report as no longer relevant.

Similarly, a produce seller is able to survey and evaluate the outstanding bids for a particular commodity item and might decide that it is advantageous to immediately sell at the current price, notwithstanding a higher posted “ask” for that commodity. The seller may also implement “include” and “exclude” filters in order to condition their display to show only a desired set of buyers and/or competitors. If a particularly desirable buyer posts a bid which is reasonably close to the seller's asking price, or if a major competitor posts an asking price substantially lower than the seller of interest has posted, the seller might select a particular buyer entry by either manipulating their mouse or by highlighting the buyer data item and pushing a “sell” button bar. This indicates to the exchange that this particular seller wishes to fill this particular buyer's outstanding order at that buyer's bid price and (by default) at that buyer's bid lot size. This information is also forwarded to the exchange's server system where it is processed in a manner similar to purchase order information and subsequently posted as a consummated trade. A new “last” price is established for that particular item as well as a new “last” quantity traded. Quantities required and quantities available for that particular buyer and seller are manipulated by the system in order to account for the recently consummated trade and, if the seller supplies are exhausted or if the buyer's requirements are fully satisfied, their entries are removed from currency status.

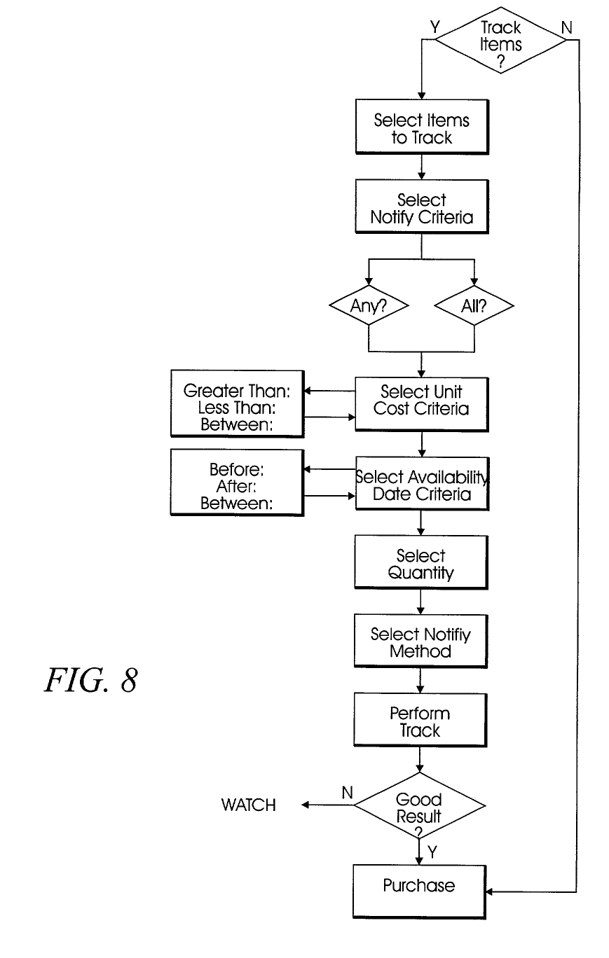

It should further be understood that in addition to enabling immediate transactions initiated by either a buyer or a seller, on a manual basis, the system in accordance with the invention can also support automatic trading by allowing both buyers and sellers to establish threshold or window criteria against which prices and quantities are evaluate for automatic purchase. An exemplary flow diagram of an automated purchasing process is depicted in FIG. 8, but should be understood to be easily portable to the perspective of a seller by merely changing the appropriate buy/sell criteria. In the exemplary flow diagram of FIG. 8, a user must first set the notification criteria against which an automatic purchase is to be effected. The set criteria might be any one of a number of different purchase or sales criteria such as price, quantity or availability from a specific participant. Conversely a user might choose to set all notification criteria so as to completely bound the transaction decision.

In the case of unit cost criteria, a buyer might choose to establish a unit cost threshold “less than” a particular price metric or “between” two bounding price criteria. The upper level of the “between” metric might represent the highest cost that a buyer wishes to incur, while the lower limit might be a subjective criteria set by the buyer in order to filter out “low-ball” offers by sellers with lower quality product.

Similarly, the buyer might select a particular quantity that they desire to purchase with either the quantity metric being the primary selection criteria, a secondary selection criteria in combination with a unit cost criteria, or the buyer need not select a particular quantity at all, the buyer believes they are able to absorb the entire market at the set unit cost.

In the case of futures purchases, the buyer might also wish to establish a “date availability” criteria to enable the automatic system to search for futures contracts that might come due “before” an established date, “after” an established date or “between” a bounded date region. The “date availability” criteria may be set either alone, or in combination with other criteria such as unit cost or quantity in order to establish a bounded set of transaction metrics.

Optionally, a buyer might be able to select from among a set of notification criteria such that the buyer can be alerted that a particular transaction has been consummated by a variety of different notification means. Specifically, the buyer might request that a notification alert be provided by e-mail to his terminal, or perhaps by alpha-numeric page to his pager system, cellular telephone, or the like. Once the criteria have been set and the notification selected, the track is launched and the items selected for tracking are polled by the system either on a continuous basis, or at any time that trading activity has established a change in a particular item's market statistics. This activity continues until an item or items have matched the selected criteria, at which time a purchase order is automatically generated and the transaction consummated.

In the case of a seller, they might wish to establish certain criteria against which their market is evaluated and which might enable automatic bid fulfillment as soon as a particular bid reaches the established criteria, regardless of any ask price posted by that seller. The seller might thereby post a slightly higher than expected ask price, in anticipation of a rising market or of getting lucky, bolstered by an automated bid acceptance routine having price criteria that might be more realistic given present market conditions.

It should be understood that a great deal of flexibility is available to both buyers and sellers when using the top-level data available through the system's trading screens in conjunction with automated purchasing and selling routines as described above. Automating the trading activity, while presenting trades in a true level-2 format gives registered users of the agricultural commodity exchange a degree of freedom in commodity trading heretofore unrealized in the agricultural commodity industry. The system is particularly adapted to streamline the selling process and mitigate the risks of effecting a transaction in order to establish a genuine “open market” for agricultural produce. Providing actual level-2 trading capabilities to wholesale buying creates a powerful value proposition for both seller and buyer, resulting in both higher prices for sellers and procurement deficiencies for buyers.

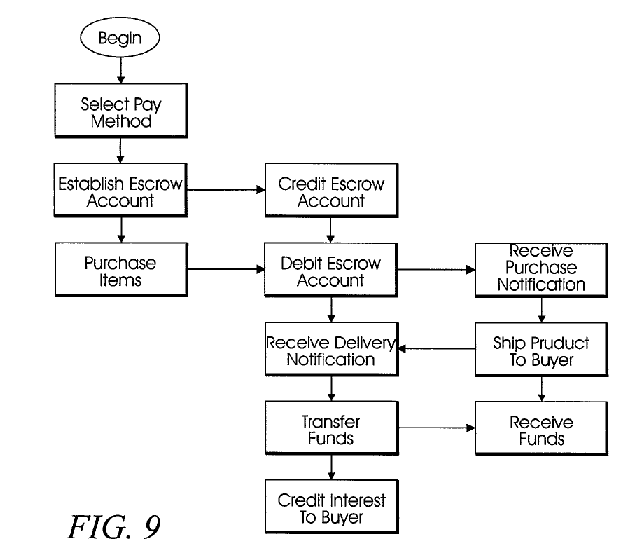

With regard to minimizing transactional risk for both buyers and sellers, the agricultural trading exchange, in accordance with the invention, implements a novel escrow account approach illustrated in the exemplary process flow diagram of FIG. 9. As indicated in the exemplary process flow, a buyer need only establish an account with the exchange and fund the account through appropriate selection of a payment method. Accounts may be funded in any one of a number of conventionally recognized means and which need not be further detailed herein. Suffice it to say that once an account is established and funded, a buyer is now able to trade with payment for purchases taken directly from that buyer's established account. The account might be maintained in a commercial institution selected by the buyer or alternatively a commercial institution selected by the exchange, but will nevertheless be a financial institution capable of receiving and maintaining funds, paying interest thereon, and the like such that the buyer is assured of never loosing his “float” .

Once the buyer's account has been established, a buyer's escrow account is credited with the sum of the funds available to the buyer to use against purchases. As a buyer effects a purchase transaction, the total costs allocated to that transaction, including the cost of goods sold, shipping costs, environmental requirements costs, and the like are summed and a debit entry made in the buyer's escrow account. Funds are not yet transferred from buyer to seller, such that the buyer maintains his float.

Simultaneously, the seller receives a purchase notification from the exchange including all of the necessary data and information that the seller needs to ship the particular quantity of produce to that particular buyer. The seller invoices the buyer, and delivers the produce to the loading dock, whence it is shipped to the buyer's receiving facility. Once received, the exchange obtains delivery notification, either from the purchaser or from the shipper, and transfers actual funds from the buyer's account to the seller's account, making sure to credit any interim interest earned on the buyer's funds to the buyer.

Thus, in addition to transactions being consummated in an extremely rapid fashion, fund transfers are made in a very secure and timely manner, depending only on a shipping company's delivery schedule. Sellers are therefore assured of receiving the agreed upon price within a very determinable time period. It is certainly within the contemplation of the present invention that these transactions shall be made on such a regular basis that a grower might even be able to sell them, as accounts receivable contracts, to financial institutions at a very favorable discount rate.

It is also important to note that while a present invention has been described in the context of a fully functional set of data processing systems, presentation screens, activity windows, and the like, those skilled in the art will appreciate that the systems and mechanisms of the present invention are capable of being implemented in a variety of forms and formats, and that the present invention applies equally regardless of the particular type of network being used to distribute the information, and indeed the specific form and format of the information being distributed over the network. Agricultural commodities listed by the exchange are certainly not limited to those items shown in the exemplary or illustrative embodiments described above but rather include all manner of perishable agricultural commodities including grains, soy beans, cotton, livestock, dairy, poultry, seafood, cut flowers, and the like. Further, trading in the exchange could very easily include farm supply commodities such as irrigation systems, pesticides, harvest supplies, shop supplies, bulk fuel, machinery, seed, and nursery plants. The clear superiority of this form of commodity trading over conventional electronic “B-to-B exchanges” or auctions suggests that various other commodity markets not specifically discussed above might also be implemented in accordance with the systems and methods of the present invention.

While the invention has been particularly shown and described with reference to the above-discussed exemplary embodiments, it will be understood by those skilled in the art that various changes and modifications in form and detail may be made to those exemplary embodiments without departing from the scope and spirit of the present invention which is defined only with regard to the following claims.

1. A method for effecting a transaction in agricultural commodities on an agricultural commodity exchange, comprising:
establishing a communication network defining a community of buyers and sellers of agricultural commodities;
receiving a first multiplicity of seller asks, over the communication network, from a plurality of selling entities, each seller ask corresponding to a particular agricultural commodity;
receiving a second multiplicity of buyer bids, over the communication network, from a plurality of buying entities, each buyer bid corresponding to a particular agricultural commodity;
posting said first multiplicity of seller asks and second multiplicity of buyer bids to the community of buyers and sellers over the communication network in the form of level-2 trading data;
executing at least one transaction between a buyer and a seller with respect to a particular agricultural commodity by a buyer's making an electronic indication on a respective posted seller ask for that particular commodity.

2. The method according to claim 1, further comprising the step of executing at least one transaction between a buyer and a seller with respect to a particular agricultural commodity by a seller's making an electronic indication on a respective posted buyer bid for that particular commodity.

3. The method according to claim 2, wherein each respective buyer bid is associated with a desired quantity index and wherein each respective seller ask is associated with a corresponding inventory index.

4. A method for effecting efficient electronic transactions in agricultural commodities, comprising:
establishing an agricultural commodity exchange, including a communication network linking a community of buyers and sellers of agricultural commodities;
receiving a multiplicity of seller asks, each seller ask associated with a corresponding inventory index, from a plurality of selling entities, each seller ask corresponding to a particular agricultural commodity;
receiving a multiplicity of buyer bids, each buyer bid associated with a corresponding desired quantity index, from a plurality of buying entities, each buyer bid corresponding to a particular agricultural commodity;
posting said multiplicity of seller asks and said multiplicity of buyer bids to the community of buyers and sellers over the communication network in the form of level-2 trading data;
accommodating changing market conditions by facilitating immediate electronic changes to inventory and desired quantity indices in any or all of the multiplicity of buyer bids or seller asks; and
posting the modified buyer bids and seller asks in real-time to the community of buyers and sellers over the communication network in the form of level-2 trading data, as changes are made.

5. The method according to claim 4, further comprising:
accommodating changing market conditions by facilitating immediate electronic changes to seller asking prices and buyer bid prices in any or all of the multiplicity of buyer bids or seller asks; and
posting the modified buyer bids and seller asks in real-time to the community of buyers and sellers over the communication network in the form of level-2 trading data, as changes are made.

6. A system for effecting efficient electronic transactions in an agricultural marketplace, comprising:
an agricultural trading platform, including a communication network linking a community of participating buyers and sellers of agricultural items, the trading platform including a server system coupled to user access devices over the communication network;
a database, the database structured in accordance with a categorical hierarchical structure, the top-level categories of the database corresponding to top-level market subdivisions comprising the agriculture related marketplace, the database containing a plurality of transaction offer notices for agricultural items organized in accordance with a corresponding one of the plurality of top-level markets;
a set of blank transaction offer notices in the form of a data record defining a transaction's parameters, each participating entity providing appropriate transaction parameters in the data record;
a plurality of completed transaction offer notices stored in the database;
a search engine, hosted by the server system, the search engine searching the database for transaction notices in accordance with a query corresponding to at least one transaction parameter; and
a negotiation engine, hosted by the server system, the negotiation engine facilitating an electronic transfer of a modified transaction offer notice between an originating party and a negotiating party.

7. The system according to claim 6, further comprising:
a posting engine, the posting engine presenting blank transaction offer notices to a participating entity, the posting engine storing completed transaction offer notices in the database for access by the search engine; and
a management engine, coupled to the database, the management engine organizing and displaying a history of transaction notices originated by and transactions completed by a corresponding participating entity.

8. The system according to claim 7, wherein the search, negotiation, and posting engines interact with a participating entity over a set of user specific presentation screens, the presentation screens accessible by a user through a browser application.
